(19) United States
(12) Patent Application Publication
(10) Pub. No.: US 2024/0416318 A1
(43) Pub. Date: Dec. 19, 2024

(54) ADSORBENT AND METHOD FOR MANUFACTURING ADSORBENT

(71) Applicant: DIC Corporation, Tokyo (JP)

(72) Inventors: Taku Ibaraki, Ichihara-shi (JP); Takashi Furusawa, Ichihara-shi (JP)

(73) Assignee: DIC Corporation, Tokyo (JP)

(21) Appl. No.: 18/695,126

(22) PCT Filed: Sep. 29, 2022
(86) PCT No.: PCT/JP2022/036340

§ 371 Date: Mar. 25, 2024

(30) Foreign Application Priority Data
Nov. 4, 2021 (JP) 2021-180113

(51) Int. Cl. B01J 20/26; B01J 20/28; B01J 20/285; B01J 20/30; C02F 1/28; C02F 101/10

(52) U.S. Cl. CPC B01J 20/262; B01J 20/28059; B01J 20/28061; B01J 20/285; B01J 20/3071; C02F 1/285; B01J 2220/52; C02F 2101/10

(57) ABSTRACT

Provided are an adsorbent containing a porous body of a polyarylene sulfide (PAS) resin capable of separating a liquid containing a substance to be separated into the substance to be separated and the liquid, and a method for manufacturing the same. Specifically, a method for manufacturing an adsorbent includes a step of heating a mixture (A) containing at least a PAS resin and an organic polar solvent at 200° C. or higher to dissolve the PAS resin in the organic polar solvent; a step of, after solid-liquid separation, cooling the mixture (A) to a temperature equal to or lower than a glass transition temperature of the PAS resin to obtain a mixture (B); and a step of washing the mixture (B) by contact with water to obtain a mixture (C) containing at least the PAS resin and water.

### TECHNICAL FIELD

The present invention relates to an adsorbent containing a polyarylene sulfide resin and a method for manufacturing the adsorbent.

### BACKGROUND ART

In recent years, from the viewpoint of both effective utilization of valuable resources and prevention of environmental pollution, attention has been paid to efficiently separating, from an aqueous solution containing metal atoms that are valuable resources, the metal atoms. A strong acid condition is often required to dissolve metal atoms in water, and therefore an adsorbent that is usable even at a wide pH range, is easy to reuse, and is excellent in adsorption power is desired. In particular, noble metals called rare metals that are typified by gold, platinum, and palladium, among valuable metals, have scarcity value, and therefore an excellent adsorbent that can selectively recover the noble metal is desired. From the viewpoint of prevention of environmental pollution, attention has been paid to efficiently separating a protonic organic solvent from wastewater for improvement in TOC removal rate in the wastewater.

On the other hand, use of a porous body formed from a polyarylene sulfide resin (hereinafter also abbreviated as PAS resin) as an adsorbent by utilizing its characteristics such as high heat resistance and chemical resistance has been proposed. For example, PTL 1 discloses that a PAS resin is used as an adsorbent, particularly a filter material for removal of ozone and NO₂ by utilizing an increased specific surface area of recycled PAS resin.

For example, PTL 2 discloses a polyphenylene sulfide as an adsorbent formed from a finely porous polymer composition having a hydrogen bonding force component δh, of three-dimensional solubility parameters, of 1 to 5 (cal^{1/2} cm^{-3/2}).

### CITATION LIST

### Patent Literature

PTL 1: Japanese Patent Application No. 8-512891
PTL 2: Japanese Unexamined Patent Application Publication No. 6-327970

### SUMMARY OF INVENTION

### Technical Problem

However, the surface of the PAS resin is highly hydrophobic, and therefore the PAS resin is not suited for applications of solid-liquid separation in which a separation object is adsorbed and separated from a liquid including water. For description of the adsorptive properties of the PAS resin, it is not enough to describe a property inherent to the chemical structure of the resin, such as δh, and there is a need for identification of the surface state of an adsorbent.

An object of the present invention is to provide an adsorbent containing a porous body of a PAS resin that can separate a liquid containing a substance to be separated into the substance to be separated and the liquid, and a method for manufacturing the same.

### Solution to Problem

The inventors of the present application have made various investigations, and as a result, found that when a mixture containing a PAS resin and an organic polar solvent is washed with the mixture being cooled to a temperature equal to or lower than the glass transition temperature of the PAS resin and the water content of the mixture is then controlled, PAS resin particles having a zeta potential of a specific range can be produced, and an adsorbent containing the PAS resin particles is excellent in a property of separating a liquid containing a substance to be separated, such as metal and an organic polar solvent, into the substance to be separated and the liquid. Thus, the present invention has been completed.

Specifically, a method for manufacturing an adsorbent of the present disclosure includes:
a step (1) of heating a mixture (A) containing at least a polyarylene sulfide resin (and an organic polar solvent at 200° C. or higher to dissolve the polyarylene sulfide resin in the organic polar solvent;
a step (2) of removing a part of a liquid-phase component by solid-liquid separation and then cooling the mixture (A) to a temperature equal to or lower than a glass transition temperature of the polyarylene sulfide resin to obtain a mixture (B); and
a step (3) of washing the mixture (B) by contact with water and removing a part of a liquid-phase component by solid-liquid separation to obtain a mixture (C) containing at least the polyarylene sulfide resin and water, in which
an amount of the organic polar solvent contained in the mixture (B) is 50 parts by mass or more relative to 100 parts by mass of the polyarylene sulfide resin contained in the mixture (B), and
an amount of the water contained in the mixture (C) is within a range of 10 to 150 parts by mass relative to 100 parts by mass of the polyarylene sulfide resin contained in the mixture (C).

An adsorbent of the present disclosure contains
a PAS resin having a zeta potential measured at a pH of 7.8 to 8.2 through a streaming potential method of −50 mV or more and water, and
the amount of water mixed is within a range of 10 to 150 parts by mass relative to 100 parts by mass of the PAS resin.

### Advantageous Effects of Invention

The present invention can provide an adsorbent containing a porous body of a PAS resin that can separate a liquid containing a substance to be separated into the substance to be separated and the liquid, and a method for manufacturing the same.

### DESCRIPTION OF EMBODIMENTS

Hereinafter, an embodiment of the present invention (hereinafter also referred to as “embodiment”) will be described in detail, but the present invention is not limited to the following description, and various modifications can be made within the scope of the present invention.

### (Method for Manufacturing Adsorbent)

A method for manufacturing an adsorbent according to the embodiment includes:
a step (1) of heating a mixture (A) containing at least a PAS resin and an organic polar solvent at 200° C. or higher to dissolve the PAS resin in the organic polar solvent;
a step (2) of removing a part of a liquid-phase component by solid-liquid separation and then cooling the mixture (A) to a temperature equal to or lower than the glass transition temperature of the PAS resin to obtain a mixture (B); and
a step (3) of washing the mixture (B) by contact with water and removing a part of a liquid-phase component by solid-liquid separation to obtain a mixture (C) containing at least the PAS resin and water. The method will be described in detail below.

### Step (1)

The step (1) is a step of heating a mixture (A) containing at least a PAS resin and an organic polar solvent at 200° C. or higher to dissolve the PAS resin.

The mixture (A) used in the step (1) is not particularly limited as long as it is a mixture containing at least a PAS resin and an organic polar solvent. For example, a crude reaction mixture containing at least a PAS resin and an organic polar solvent that is obtained by a method for polymerizing a PAS resin described below, a mixture of a purified PAS resin and an organic polar solvent, a mixture of a recycled PAS resin and an organic polar solvent, or the like can be used.

In addition to a PAS resin and an organic polar solvent, the mixture (A) used in the step (1) may contain, for example, a side product, such as a cyclic PAS oligomer, a linear PAS oligomer, an alkali metal-containing inorganic salt, a carboxyalkylamino group-containing compound, or a terminal SH group-containing compound, an unreacted raw material, water, a filler, a resin other than PAS, or the like. In particular, it is preferable that the alkali metal salt be contained since the zeta potential value of the surface of the PAS particles obtained after a washing step of the step (3) is increased.

The PAS resin used in the embodiment has a resin structure containing as a repeating unit a structure in which an aromatic ring is bonded to a sulfur atom. Specifically, the PAS resin composition is a resin containing a structural moiety represented by the following general formula (1):

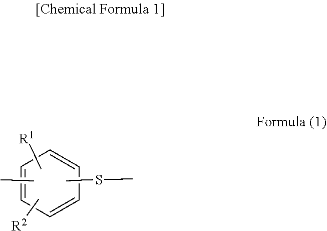

(where R¹ and R² are each independently a hydrogen atom, an alkyl group having 1 to 4 carbon atoms, a nitro group, an amino group, a phenyl group, a methoxy group, or an ethoxy group), and if necessary, a trifunctional structural moiety represented by the following general formula (2):

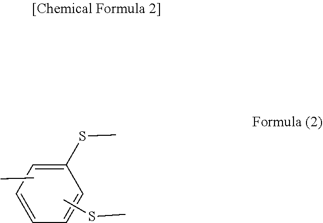

as repeating units. The amount of the trifunctional structural moiety represented by the formula (2) is preferably within the range of 0.001 to 3% by mole, and particularly preferably within the range of 0.01 to 1% by mole, relative to the total number of moles of other structural moieties.

Herein, the structural moiety represented by the formula (1), especially R¹ and R² in the formula are preferably a hydrogen atom in terms of mechanical strength of the PAS resin. In this case, examples of the structural moiety include a structural moiety represented by the following formula (3) and having bonds at para positions and a structural moiety represented by the following formula (4) and having bonds at meta positions.

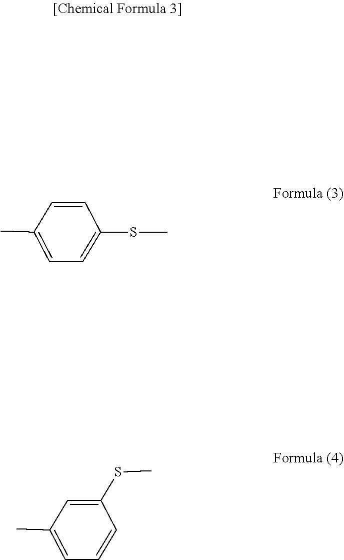

In particular, the structural moiety represented by the general formula (3) in which a bond of the aromatic ring to the sulfur atom in the repeating unit is a bond at a para position is preferable in terms of heat resistance and crystallinity of the PAS resin.

The PAS resin may contain not only the structural moieties represented by the formulae (1) and (2), but also structural moieties represented by the following structural formulae (5) to (8):

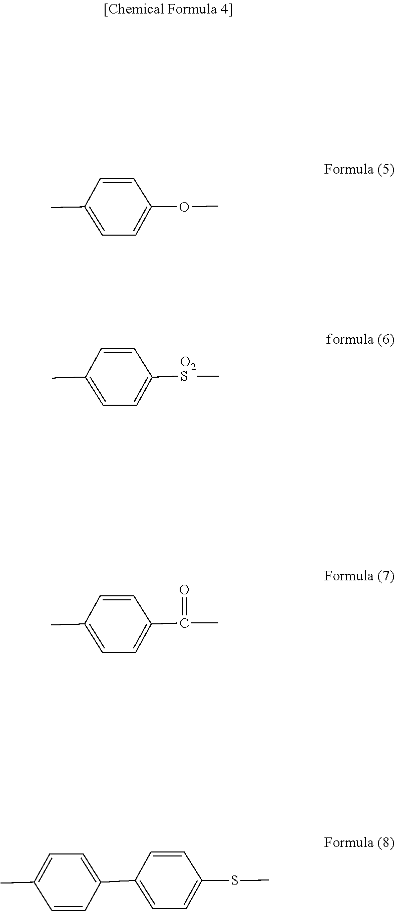

in an amount of 30% by mole or less relative to the total amount of the structural moieties represented by the formulae (1) and (2). In particular, in the present invention, it is preferable that the amount of the structural moieties represented by the general formulae (5) to (8) be 10% by mole or less in terms of heat resistance and mechanical strength of the PAS resin. When the PAS resin contains the structural moieties represented by the general formulae (5) to (8), the structural moieties may be bonded at any pattern to form any of a random copolymer or a block copolymer.

The molecular structure of the PAS resin may have a naphthyl sulfide bond and the like, and the amount thereof is preferably 3% by mole or less, and particularly preferably 1% by mole or less, relative to the total amount of the molecular structure and another structural moiety.

A polymerization method for the PAS resin is not particularly limited as long as it is a publicly known method, and examples thereof include: polymerization methods such as (polymerization method 1) a method in which a dihaloaromatic compound, and if necessary, a polyhaloaromatic compound or another copolymerization component are polymerized in the presence of sulfur and sodium carbonate; (polymerization method 2) a method in which a dihaloaromatic compound, and if necessary, a polyhaloaromatic compound or another copolymerization component are polymerized in a polar solvent in the presence of sulfide-forming agent and the like; (polymerization method 3) a method for self-condensing p-chlorothiophenol, with another copolymerization component if necessary; and (polymerization method 4) a method in which a diiodo aromatic compound and a simple substance sulfur are melt-polymerized under reduced pressure in the presence of a polymerization inhibitor that may have a functional group, such as a carboxy group and an amino group. Among these polymerization methods, the polymerization method 2 is preferred since it is widely used. During a reaction, an alkali metal salt of carboxylic acid or sulfonic acid may be added, or an alkali hydroxide may be added to adjust the degree of polymerization. In the polymerization method 2, it is particularly preferable that the PAS resin be obtained by a method in which a water-containing sulfide-forming agent is introduced into a mixture containing a heated organic polar solvent and a dihaloaromatic compound at a speed at which water can be removed from a reaction mixture, and if necessary, a polyhaloaromatic compound is added, the dihaloaromatic compound and the sulfide-forming agent are reacted in the organic polar solvent, and the amount of water in the reaction system is controlled within the range of 0.02 to 0.5 moles relative to 1 mole of the organic polar solvent to produce the PAS resin (see Japanese Unexamined Patent Application No. H07-228699), a method in which a dihaloaromatic compound, and if necessary, a polyhaloaromatic compound or another copolymerization component are reacted with an alkali metal hydrosulfide and an alkali metal salt of an organic acid in the presence of a solid alkali metal sulfide and an aprotic polar organic solvent while the amount of the alkali metal salt of an organic acid is controlled within the range of 0.01 to 0.9 moles relative to 1 mole of sulfur source and the amount of water in the reaction system is controlled to be 0.02 moles or less relative to 1 mole of the aprotic polar organic solvent (see WO2010/058713).

Specific examples of the dihaloaromatic compound include p-dihalobenzene, m-dihalobenzene, o-dihalobenzene, 2,5-dihalotoluene, 1,4-dihalonaphthalene, 1-methoxy-2,5-dihalobenzene, 4,4′-dihalobiphenyl, 3,5-dihalobenzoic acid, 2,4-dihalobenzoic acid, 2,5-dihalonitrobenzene, 2,4-dihalonitrobenzene, 2,4-dihaloanisole, p, p′-dihalodiphenyl ether, 4,4′-dihalobenzophenone, 4,4′,-dihalodiphenyl sulfone, 4,4′,-dihalodiphenyl sulfoxide, 4,4′-dihalodiphenyl sulfide, and compounds having an alkyl group having 1 to 18 carbon atoms as a nuclear substituent on the aromatic ring of any of the aforementioned compounds. Examples of the polyhaloaromatic compound include 1,2,3-trihalobenzene, 1,2,4-trihalobenzene, 1,3,5-trihalobenzene, 1, 2, 3, 5-tetrahalobenzene, 1,2,4,5-tetrahalobenzene, and 1,4,6-trihalonaphthalene. A halogen atom contained in the aforementioned compounds is desirably a chlorine atom or a bromine atom.

A crude reaction mixture containing the PAS resin obtained by a polymerization step may be subjected to a post-treatment. In this case, a method for the post-treatment is not particularly limited. Examples thereof include (post-treatment 1) a method in which after completion of a polymerization reaction, a solvent is distilled off under reduced pressure or normal pressure from the reaction mixture as it is or after addition of an acid or a base, a solid material after distillation of the solvent is washed with a solvent such as water, the reaction solvent (or an organic solvent having the same solubility in a low molecular weight polymer), acetone, methyl ethyl ketone, and an alcohol, one or two or more times, followed by neutralization, water-washing, filtration, and drying; (post-treatment 2) a method in which after completion of a polymerization reaction, a solvent (a solvent that is soluble in the solvent used for polymerization and is a poor solvent to at least PAS) such as water, acetone, methyl ethyl ketone, an alcohol, an ethyl, a halogenated hydrocarbon, an aromatic hydrocarbon, and an aliphatic hydrocarbon is added as a precipitating agent, to precipitate PAS and a solid product such as an inorganic salt, and they are filtered off, washed, and dried; (post-treatment 3) a method in which after completion of a polymerization reaction, a reaction solvent (or an organic solvent having the same solubility in a low molecular weight polymer) is added to the reaction mixture and then stirred, the low molecular weight polymer is removed by filtration, and the resultant is washed with a solvent such as water, acetone, methyl ethyl ketone, and an alcohol, one or two or more times, followed by neutralization, water-washing, filtration, and drying; (post-treatment 4) a method in which after completion of a polymerization reaction, water is added to wash the reaction mixture, and if necessary, an acid is added to treat the reaction mixture during water-washing, followed by filtration and drying; and (post-treatment 5) a method in which after completion of a polymerization reaction, the reaction mixture is filtered, and if necessary, washed with the reaction solvent one or two or times, and then washed with water, followed by filtration and drying.

In the post-treatment method described in the post-treatments 1 to 5, the PAS resin may be dried in vacuum, in an air, or in an inert gas atmosphere such as nitrogen.

The organic polar solvent contained in the mixture (A) is not particularly limited as long as it can dissolve the PAS resin at at least 200° C. or higher, and a publicly known organic polar solvent can be used. Examples thereof include N-methyl-2-pyrrolidone, formamide, acetamide, N-methylformamide, N, N-dimethylacetamide, 2-pyrrolidone, N-methyl-ε-caprolactam, ε-caprolactam, hexamethyl phosphoramide, tetramethyl urea, N-dimethylpropylene urea, 1,3-dimethyl-2-imidazolidinone acid amide urea, and lactams; sulfolanes such as sulfolane and dimethyl sulfolane; nitriles such as benzonitrile; ketones such as methyl phenyl ketone; morpholines such as N-formyl morpholine; and other solvents such as polyethylene dialkyl ether, 1-chloronaphthalene, and diphenyl sulfide.

The amount of the organic polar solvent mixed in the mixture (A) is preferably 100 parts by mass or more, and more preferably 150 parts by mass or more, and preferably 1,000 parts by mass or less, and more preferably 600 parts by mass or less, relative to 100 parts by mass of the PAS resin. When the organic polar solvent is mixed within such a range, the PAS resin can be sufficiently dissolved in the organic polar solvent, and the washing efficiency in the step (2) can be enhanced.

The temperature in heating the mixture (A) is preferably 200° C. or higher, and more preferably 230° C. or higher, and preferably 280° C. or lower. Under heating at a temperature falling within the range, the PAS resin can be in a sufficient dissolution state in the organic polar solvent.

When the mixture (A) contains a component that is not dissolved in the organic polar solvent, such as a filler, the step (1) may further include a step of removing a solid-phase component by performing solid-liquid separation such as filtration after the mixture (A) is heated to dissolve the PAS resin in the organic polar solvent.

The step (1) may further include a step of adding a water-soluble inorganic salt such as an alkali metal salt to the mixture (A). By adding the water-soluble inorganic salt, the zeta potential value of the PAS resin obtained after the washing step of the step (3) is increased.

### Step (2)

The step (2) is a step of removing a part of a liquid-phase component by solid-liquid separation and then cooling the mixture (A) to a temperature equal to or lower than the glass transition temperature of the PAS resin to obtain a mixture (B).

The solid-liquid separation is roughly classified into two kinds: a flushing method and a quenching method described below. The flushing method is a method in which the solvent in the crude reaction mixture is evaporated to collect the solvent and at the same time, to collect the solid, and is generally a method in which the crude reaction mixture is flushed from a high-temperature and high-pressure state to a normal-pressure or reduced-pressure atmosphere, to distill and collect the solvent, and at the same time to powder and collect the solid containing the PAS resin. Examples of a preferable aspect of the flushing method include a method of jetting a polymerization reactant at high temperature and high pressure (usually 250° C. or higher and 0.8 MPa or higher) obtained in the polymerization step through a nozzle to an atmosphere of nitrogen or water vapor under normal pressure. In the flushing method, the solvent can be more efficiently collected by rapid cooling (quenching) utilizing the vaporization heat of the solvent when the polymerization reactant is flushed from the high-temperature and high-pressure state to the normal-pressure state. As the inner temperature in flushing is higher, the collection efficiency of the solvent is increased, and the productivity is also improved. The temperature and pressure in the polymerization system in flushing are typically a temperature range of 250° C. or higher, and preferably 255 to 280° C., and a pressure range of 0.8 MPa or more, and preferably 1.0 to 5.0 MPa. The atmosphere temperature in flushing from this state to reduced pressure or normal pressure is typically within the range of 150 to 250° C. Using the flushing method is preferred since the PAS resin can be collected in the form of porous particles by quenching. When a filter and the like are provided in a pipe through which the mixture (A) passes in flushing, a component insoluble in the heated organic polar solvent contained in the mixture (A), such as the filler, can be removed.

On the other hand, the quenching method is a method in which the crude reaction mixture is annealed to collect the PAS resin in the form of particles, and is generally a method in which the crude reaction mixture is gradually cooled from a high-temperature and high-pressure state to crystallize the PAS resin in the reaction system, and the PAS resin is subjected to solid-liquid separation by filtration and the like, to collect a solid component containing the PAS resin in the form of granules. The cooling time is not particularly limited, and a preferable range thereof is typically 0.1° C./min to 5° C./min. In the whole annealing step, annealing at the constant speed is not necessitated. A method in which cooling is performed at a speed of 0.1° C./min to 1° C./min until the PAS resin in the form of granules is crystallized, and then at a speed of 1° C./min or more, or the like is preferred. It is preferable that cooling be performed finally to 70° C. or higher, preferably 100° C. or higher and 200° C. or lower, and the solid component containing a polyarylene sulfide resin be then collected by solid-liquid separation. In the solid-liquid separation in the quenching method, separation can be achieved by filtration or using a centrifugal separator such as a screw decanter. In separation by filtration or using a centrifugal separator such as a screw decanter, the PAS resin having a particle diameter of 10 μm or less may be sieved and removed using a metal mesh or the like. When the resin having a small particle diameter is removed, an increase in filtration pressure using a column filled with an adsorbent can be reduced.

It is preferable that the amount of a liquid-phase component to be removed by solid-liquid separation in the step (2) be adjusted such that the amount of the organic polar solvent contained in the mixture (B) is preferably 50 parts by mass or more, more preferably 100 parts by mass or more, and preferably 300 parts by mass or less, and more preferably 200 parts by mass or less, relative to 100 parts by mass of the PAS resin contained in the mixture (B). Such a range is preferred since the zeta potential of the PAS resin is high, that is, the surface state of the PAS resin is more hydrophile to improve the adsorption performance of the adsorbent.

The mixture (B) obtained by solid-liquid separation is preferably cooled to a temperature equal to or lower than the glass transition temperature of the PAS resin. The cooling can be performed by a publicly known method. When the mixture (B) is cooled to a temperature equal to or lower than the glass transition temperature, the PAS resin can be collected in the form of porous particles having a large specific surface area.

### Step (3)

The step (3) is a step of washing the mixture (B) by contact with water and removing a part of a liquid-phase component by solid-liquid separation to obtain a mixture (C) containing at least the PAS resin and water. From the viewpoint of maintaining the specific surface area of the particles, the step (3) is preferably performed at a temperature equal to or lower than the glass transition temperature of the PAS resin.

The temperature of water coming into contact with the mixture (B) is not particularly limited, and is preferably 10° C. or higher, and more preferably 20° C. or higher, and preferably 90° C. or lower, more preferably 70° C., and further preferably 50° C. or lower. After washing, it is preferable that solid-liquid separation be performed by filtration, to obtain a cake of the solid. The amount of the water used in the single washing is not particularly limited, and is preferably 20 part by mass or more, more preferably 50 parts by mass or more, and further preferably 100 parts by mass or more, and preferably 10,000 parts by mass or less, more preferably 5,000 parts by mass or less, and further preferably 2,000 parts by mass or less, relative to 100 parts by mass of the PAS resin.

In solid-liquid separation in the step (3), for example, a filtration method using a filtration device, a method in which to a filtration residue containing moisture obtained by filtration (hereinafter also abbreviated as “water-containing cake”), water is added again to obtain a slurry, and the slurry is filtered (slurry filtrating), a method in which water is added again with the water-containing cake being held in a filter, and filtration is performed (cake washing and filtrating), or the like can be performed. At that time, it is preferable that adjustment be performed so as not to completely remove water. For example, the amount of water contained in the mixture (C) is preferably adjusted to 10 parts by mass or more, more preferably 50 parts by mass or more, and further preferably 80 parts by mass or more, and preferably 150 parts by mass or less, more preferably 140 parts by mass or less, and further preferably 130 parts by mass or less, relative to 100 parts by mass of the PAS resin. Such a range is preferred since the affinity of the adsorbent to the solution is improved to improve the adsorption performance.

From the viewpoint of increasing the zeta potential value of the surface of the PAS resin, the step (3) may include a step of washing the mixture (B) by contact with an oxygen atom-containing solvent having 1 to 3 carbon atoms before contact between the mixture (B) and water.

Examples of the oxygen atom-containing solvent having 1 to 3 carbon atoms include, but are not particularly limited to, at least one selected from the group consisting of alcohol-based solvents and ketone-based solvents. Examples of the alcohol-based solvent (also referred to as alcohol solvent) include alcohols having 3 or less carbon atoms such as methyl alcohol, ethyl alcohol, n-propyl alcohol, isopropyl alcohol, ethylene glycol, and propylene glycol; alcohols having 3 or less carbon atoms and an ether bond such as 2-methoxyethyl alcohol; alcohols having 3 or less carbon atoms and a ketone group; and alcohols having a 3 or less carbon atoms and an ester group. Examples of the ketone-based solvent (also referred to as ketone solvent) include acetone. In the present invention, it is preferable that a monohydric alcohol having 3 or less carbon atoms be used since the remaining carboxylalkylamino group-containing compound can be efficiently removed. A step (2Ss) may be performed after an aqueous solution is obtained by adding water to the oxygen atom-containing solvent having 1 to 3 carbon atoms to reduce the concentration. In this case, the concentration of the oxygen atom-containing solvent having 1 to 3 carbon atoms in the aqueous solution is not particularly limited, and is preferably 90 parts by mass or less relative to 100 parts by mass of the aqueous solution. The concentration is more preferably 85 parts by mass or less, and preferably 25 parts by mass or more, and more preferably 45 parts by mass or more.

The temperature in adding the oxygen atom-containing solvent having 1 to 3 carbon atoms is not particularly limited, and is preferably 10° C. or higher, and more preferably 20° C. or higher, and preferably 90° C. or lower, and more preferably 70° C. or lower. The amount of the solvent used in the single washing is not particularly limited, and is preferably 20 part by mass or more, more preferably 50 parts by mass or more, and further preferably 100 parts by mass or more, and preferably 5,000 parts by mass or less, more preferably 1, 800 parts by mass or less, and further preferably 600 parts by mass or less, relative to 100 parts by mass of the PAS resin.

When the mixture was washed by contact with the oxygen atom-containing solvent having 1 to 3 carbon atoms, it is preferable that the oxygen atom-containing solvent having 1 to 3 carbon atoms used in the washing be removed by solid-liquid separation before the subsequent step of washing the mixture with water.

The step (3) may further include a step of washing the mixture (B) by contact with carbonated water before or after the contact between the mixture (B) and water.

As conditions in contact between the mixture (B) and carbonated water, the temperature is preferably 10° C. or higher, and more preferably 20° C. or higher, and preferably 90° C. or lower, and more preferably 70° C. or lower, and the pressure (gauge pressure) is less than 0.1 MPa, preferably 0.05 MPa or less, and further preferably atmospheric pressure or less.

The amount of carbonated water used in contact with the mixture (B) is not particularly limited. Since the contact between the PAS resin and carbonated water is favorably achieved and the purification efficiency is further suitable, the amount of carbonated water is preferably 50 parts by mass or more, more preferably 100 parts by mass or more, and further 200 parts by mass or more, and preferably 10,000 parts by mass or less, more preferably 5,000 parts by mass or less, and further preferably 2,000 parts by mass or less, relative to 100 parts by mass of the PAS resin.

Using carbonated water for washing is preferred. This is because a metal is hardly corroded under a typical purification temperature condition (100° C. or lower), the washing is applicable using an ongoing device, and a relatively inexpensive material having corrosion resistance similarly to SUS304 can be resistant to corrosion. Therefore, carbonated water has a merit in terms of facility cost based on the material of the device as compared with other acids, and does not require a pressure-resistant container. In addition to the merit in terms of facility cost, carbonated water is excellent in maintenance and safety.

When the other acids remain in the PAS resin (in particular, chlorine ions, sulfate ions, and the like are likely to remain in the polymer), the other acids are major causes of mold corrosion during molding and a reduction in physical properties of a molded article. However, in a purification method using carbonated water of the present invention, the carbonated water is easily removed also in water-washing step that is a subsequent step, and is decomposed and scattered from the PAS resin in a drying step. Therefore, carbonated water used for washing is difficult to cause mold corrosion and a reduction in physical properties of the molded article, unlike the other acids.

When a strong acid other carbonated water is used, a large amount of water and frequent washing are required after washing with the strong acid for removal of acid remaining in the PAS resin. However, in the purification method using carbonated water of the present invention, the amount of water used after washing with carbonated water is small, and the washing frequency can be reduced. Therefore, using carbonated water for washing highly has a merit in terms of process capability and is a suitable process in terms of environmental countermeasures.

In washing with carbonated water, it is preferable that the carbonated water used in the washing be removed by solid-liquid separation before the subsequent step of washing the mixture with water.

When the mixture (B) contains a resin other than the PAS resin or an organic substance such as an additive, the step (3) may further include a step of extracting and removing the resin other than the PAS resin and the organic substance such as the additive using an organic solvent before washing with water. In this case, it is preferable that the organic solvent be added to the mixture (B) and stirred, and a liquid-phase component be then removed by solid-liquid separation such as filtration. The organic solvent used in extracting the organic substance is not particularly limited as long as it dissolves the organic substance to be removed and does not dissolve the PAS resin, and a publicly known one can be used. The amount of the organic solvent used is not particularly limited as long it is the amount capable of sufficiently dissolving the organic substance to be extracted.

The adsorbent obtained by the manufacturing method according to the embodiment has the following features.

### (Zeta Potential)

The zeta potential at a pH of 7.8 to 8.2 of the PAS resin contained in the adsorbent according to the embodiment that is measured by a streaming potential method is preferably-50 mV or more, and more preferably-30 mV or more. The zeta potential of the PAS resin refers to the average value when a cylinder cell is filled with about 100 mg of the adsorbent and the zeta potential of the surface of the resin particles is measured three times with SurPASS3 (Anton Paar) in a 1 mmol/L KCl aqueous solution that is an electrolytic liquid at a measurement temperature of 22 to 26° C. For stabilization of the measured value, it is preferable that the PAS resin having a particle diameter of 0.05 to 1.0 mm be selected by sieving the PAS resin and used.

### (Specific Surface Area)

The specific surface area of the PAS resin in the form of porous particles contained in the adsorbent according to the embodiment is preferably 1 m²/g or more, more preferably 10 m²/g or more, and further preferably 50 m²/g or more, and preferably 300 m²/g or less, more preferably 250 m²/g or less, further preferably 200 m²/g or less, and particularly preferably 150 m²/g or less. The specific surface area of the PAS resin can be measured through a method described in the section of Examples. The specific surface area of the PAS resin is a BET specific surface area that is measured using “TriStar II3020” manufactured by Shimadzu Corporation after the adsorbent is pre-treated at 60° C. under a vacuum over 4 hours.

### (Particle Diameter)

The PAS resin contained in the adsorbent according to the embodiment is preferably in the form of particles. The particle diameter of the PAS resin is not particularly limited, and from the viewpoint of excellent adsorption properties, the upper limit value thereof is preferably about 2 mm, more preferably about 500 μm, and further preferably about 300 μm. From the viewpoint of excellent handleability and liquid transferring property in charging into a column or the like, the lower limit value thereof is preferably about 10 μm, more preferably about 20 μm, and further preferably about 30 μm. The average particle diameter of the PAS resin is the average particle diameter (D50) determined from the particle size distribution determined using a laser diffraction and scattering-type particle size measurement device (Microtrac MT3300EXII) in accordance with an ordinary method.

### (Water Content)

The amount of the water contained in the adsorbent according to the embodiment is preferably 10 part by mass or more, more preferably 50 parts by mass or more, further preferably 70 parts by mass or more, and particularly preferably 80 parts by mass or more, and preferably 150 parts by mass or less, more preferably 130 parts by mass or less, and further preferably 120 parts by mass or less, relative to 100 parts by mass of the PAS resin. Such a range is preferred since the affinity of the adsorbent to the solution is improved to improve the adsorption performance. The water content refers to a value determined from a weight reduction ratio when the adsorbent is dried at 60° C. under a vacuum for 4 hours.

The adsorbent according to the embodiment is preferably an adsorbent in which as an external additive component for the adsorbent (a component present outside the PAS resin particles, mainly a component present at an interface between the PAS resin particles and the liquid) an optional component other than the PAS resin particles (excluding an unavoidable component derived from the polymerization reaction of the PAS resin and water), for example, a commonly known additive such as a surfactant (dispersant), a colorant, an antistat, an antioxidant, a heat-resistant stabilizer, an ultraviolet stabilizer, an ultraviolet absorber, a foaming agent, a flame retarder, a flame retardant promoter, an antirust agent, a release agent, or a coupling agent, is absent. The absence of the optional component other than the PAS resin particles as the component constituting the adsorbent means that the content of the PAS resin particles in the adsorbent except the unavoidable component and water is preferably 95% by mass or more, more preferably 99% by mass or more, and further preferably 99.9% by mass or more. The upper limit value of the content is not particularly limited, and refers to 100% by mass or less.

The PAS resin particles are preferably PAS resin particles in which as a component of an internal additive component constituting the particles (a component present in the internal of the PAS resin particles due to melt-kneading) an optional component other than the PAS resin particles (excluding the unavoidable component derived from the polymerization reaction of the PAS resin), for example, a commonly known additive such as a surfactant (dispersant), a colorant, an antistat, an antioxidant, a heat-resistant stabilizer, an ultraviolet stabilizer, an ultraviolet absorber, a foaming agent, a flame retarder, a flame retardant promoter, an antirust agent, a release agent, or a coupling agent, is absent. The absence of the optional component other than the PAS resin as the component constituting the particles means that the content of the PAS resin contained in the PAS resin particles except the unavoidable component is preferably 95% by mass or more, more preferably 99% by mass or more, and further preferably 99.9% by mass or more. The upper limit value of the content is not particularly limited, and refers to 100% by mass or less.

When the particles of the PAS resin contain the external additive and the internal additive described above, the proportion of a sulfur component on the particle surface contributing to adsorption capacity reduces or the affinity of the particles to the solution reduces, and as a result, adsorption properties may reduce.

The adsorbent according to the embodiment can adsorb and/or separate a metal in a liquid. An example of a substance to be separated is a metal atom or a compound containing the metal atom (except that the metal atom is a sodium atom or a lithium atom). The metal atom is at least one selected from the group consisting of alkali metal atoms, alkaline earth metals, transition metal atoms, lanthanoid atoms, and actinoid atoms. The metal atoms may be present in the form of a metal atom simple substance or in the form of a compound in which the metal atoms are bound to other atoms or an alloy. Among these, a transition metal is preferred, and a metal atom classified as a soft acid according to the HSAB principle is more preferred. This is probably because the PAS resin that is the adsorbent contains as a main component a sulfur atom classified as a soft according to on the HSAB principle and has high affinity. The metal atom may react with an acid or base described below to form a salt.

The metal atom or the compound containing the metal atom (metal salt) that is the substance to be separated is not particularly limited, and examples thereof include alkali metal atoms such as potassium, rubidium, cesium, and francium; alkaline earth metal atoms such as calcium, strontium, barium, and radium; transition metal atoms such as scandium, titanium, vanadium, chromium, manganese, iron, cobalt, nickel, copper, yttrium, zirconium, niobium, molybdenum, technetium, ruthenium, rhodium, palladium, silver, cadmium, lanthanide, hafnium, tantalum, tungsten, rhenium, osmium, iridium, platinum, gold, and mercury; base metal atoms such as aluminum, zinc, gallium, germanium, indium, tin, antimony, mercury, thallium, lead, bismuth, and polonium, and salts containing the atoms. Examples of lanthanide include lanthanum, cerium, praseodymium, neodymium, promethium, samarium, europium, gadolinium, terbium, dysprosium, holmium, erbium, thulium, ytterbium, and lutetium. Examples of actinoid include actinium, thorium, protactinium, uranium, neptunium, plutonium, americium, curium, berkelium, californium, einsteinium, fermium, mendelevium, nobelium, and lawrencium. In particular, the metal atom classified as a soft acid according to the HSAB principle or a compound containing the metal atom is preferred since it is adsorbed on to the PAS resin. For example, ruthenium, rhodium, palladium, silver, cadmium, osmium, iridium, platinum, gold, mercury, thallium, and lead, and metal salts thereof are preferred, and gold, platinum, and palladium, and metal salts thereof are particularly preferred. A compound (metal salt) formed from the metal atom that is the substance to be separated is more preferred since the compound dissociates in a liquid into metal ions.

The adsorbent according to the embodiment can adsorb and/or separate a protonic organic solvent in a liquid. Examples of the protonic organic solvent include alcohol-based solvents such as methanol, ethanol, n-butanol, n-decanol, or isomers thereof, cyclopentanol, and cyclohexanol.

The liquid may be water. The liquid may contain a weak acid such as acetic acid, formic acid, carbonic acid, oxalic acid, or phosphoric acid, and further preferably a strong acid such as hydrochloric acid, sulfuric acid, nitric acid, or aqua regia.

In a separation method using the adsorbent according to the embodiment, the pH of the liquid containing the substance to be separated is not limited, and for example, under a strong acid condition, the substance to be separated can be adsorbed using the adsorbent of the present invention from the liquid containing the substance to be separated.

The separation method using the adsorbent according to the embodiment includes a step of bringing a liquid containing a substance to be separated into contact with the adsorbent to selectively adsorb the substance to be separated contained in the liquid to the adsorbent, removing the substance to be separated from the liquid. In the step, by bringing the liquid containing the substance to be separated into contact with the adsorbent, for example, by adding the adsorbent to the liquid containing the substance to be separated, the substance to be separated contained in the liquid is selectively adsorbed to the adsorbent, and thus the substance to be separated can be removed from the liquid. At that time, for prevention of aggregation of particles of the adsorbent, a mechanical shear force by stirring, vibration, ultrasonic irradiation, or the like can be applied.

The ratio of the adsorbent used relative to the liquid containing the substance to be separated is not particularly limited. When the substance to be separated is metal, the concentration of the substance to be separated is subjected to measurement and the like in advance, and the adsorbent can be used such that the ratio by weight of the adsorbent to the substance to be separated is preferably once or more, more preferably 5 times or more, and further preferably 10 times or more, and preferably 1,000 times or less, more preferably 500 times or less, and further preferably 100 times or less. When the substance to be separated is a protonic organic solvent, the adsorbent can be used such that the ratio by weight of the adsorbent to the substance to be separated is preferably 0.001 times, more preferably 0.005 times, and further preferably 0.01 times or more, and preferably 10 times or less, more preferably 5 times or less, and further preferably once or less.

The separation method using the adsorbent according to the embodiment may further include a step of separating the adsorbent from the liquid by solid-liquid separation. Examples of the solid-liquid separation include sedimentation, floatation, sand filtration, centrifugation, precise membrane filtration, and ultrafiltration membrane filtration. This step can facilitate, after the solid-liquid separation, a regeneration treatment in which the adsorbent to which the substance to be separated is adsorbed is collected and the adsorbed substance to be separated is removed, and can further facilitate reuse of the adsorbent.

For the contact between the adsorbent according to the embodiment and the liquid containing the substance to be separated, for example, the adsorbent is fixed by filling a column with the adsorbent or supporting the adsorbent on fibers or a membrane, and the liquid containing the substance is supplied to the column or the fibers or the membrane. Thus, the substance to be separated contained in the liquid can be selectively adsorbed to the adsorbent, and removed from the liquid. In this case, examples of a method in a batchwise manner include a method in which the liquid containing the substance to be separated is supplied to a container in which the adsorbent is fixed. Examples of a method in a continuous manner include a method in which the adsorbent is fixed in a flow path and the liquid containing the substance to be separated is supplied to the flow path. For the fixation, a publicly known method in which the adsorbent is compacted using a partition with a pore having a size allowing the liquid to pass but not allowing the adsorbent to pass, and then separated from the liquid can be used. When the adsorbent is fixed, solid-liquid separation between the adsorbent and the liquid can be made easy, but the adsorbent having a small particle diameter may be mixed in the liquid after the solid-liquid separation. Therefore, if this needs to be avoided, a solid-liquid separation step such as sedimentation, floatation, sand filtration, centrifugation, precise membrane filtration, or ultrafiltration membrane filtration can be separately performed for solid-liquid separation.

### EXAMPLES

Hereinafter, the present invention will be described specifically using Examples. The examples are illustrative, and are not limited. Hereinafter, “%” and “part(s)” are based on mass unless other specified.

### <Evaluation>

### (1) Measurement of Zeta Potential

By a streaming potential method, the zeta potential value of each particle surface was measured three times under the following measurement conditions using a zeta potential meter for solid SurPASS3 (Anton Paar), and the average value thereof was determined. The results are shown in Table 1.
“Measurement conditions”
Kind of cell: cylinder cell
Sample amount: about 100 mg
Sample: PAS resin particles sieved within the range of 0.05 to 1 mm
Electrolytic liquid: 1 mmol/L KCl aqueous solution
Measurement temperature: 22 to 26° C.
PH: 8.0

### (2) Evaluation of Water Content of Adsorbent

In a dish, 10.00 g of adsorbent was collected, and dried at 60° C. under a vacuum for 4 hours. From the weight before and after drying, the water content was determined using the following expression. The results are shown in Table 1.

$$Water content ( wt \% ) = ( weight ( g ) before drying - weight ( g ) after drying ) / ( weight ( g ) after drying ) \times 100$$

### (3) Measurement of Specific Surface Area

In measurement of the specific surface area of a PAS resin contained in an adsorbent, “TriStar II3020” manufactured by Shimadzu Corporation was used. The adsorbent was allowed to stand at 60° C. under a vacuum for 4 hours, pre-treated, and put into a measurement cell, and the cell was degassed and purged with helium. The cell was cooled and purged with nitrogen, and the specific surface area of the particles was measured. The results are shown in Table 1.

### (4) Evaluation of Metal Adsorptive Properties

Each adsorbent was added such that the amount of a PPS resin contained in 5 mL of 0.01 N hydrochloric acid aqueous solution obtained by dissolving a metal salt containing a metal as a substance to be separated listed in Tables 1 and 2 at 0.3 mmol/L was 0.025 g, and the resultant solution was stirred through vibration at a liquid temperature of 30° C. and 200 rpm for 3 hours. Subsequently, the aqueous solution and the adsorbent were each obtained by filtration. The concentration of the substance to be separated in the aqueous solution was determined using an ICP emission spectrophotometer (“Optima 4300DV” manufactured by PerkinElmer Japan Co., Ltd.), and the difference between the concentration and the concentration during preparation was taken as adsorption amount. The results are shown in Tables 1 and 2.

### (5) Evaluation of Protonic Organic Solvent Adsorptive Properties

Each adsorbent was added such that the amount of a PPS resin contained in 10 mL of aqueous solution containing 1.5 wt % of methanol was 0.025 g, and the resultant solution was stirred through vibration at a liquid temperature of 30° C. and 200 rpm for 3 hours. Subsequently, the aqueous solution and the adsorbent were each obtained by filtration. The concentration of methanol in the aqueous solution was determined through gas chromatography (“GC-2014” manufactured by Shimadzu Corporation), and the difference between the concentration and the concentration during preparation was taken as adsorption amount. The results are shown in Table 1.

### Synthesis Examples 1, Examples 1 to 10, and Comparative Examples 1 to 7

### Synthesis Example 1

In a 150-L autoclave having a stirrer blade equipped with a pressure gauge, a thermometer, a condenser, a decanter, and a rectification tower, 33.222 kg (226 moles) of p-dichlorobenzene (hereinafter abbreviated as p-DCB), 2.280 kg (23 moles) of N-methyl-2-pyrrolidone (hereinafter abbreviated as NMP), 27.300 kg (230 moles) of 47.23% by mass sodium hydrosulfide, and 18.533 kg (228 moles) of 49.21% by mass caustic soda were placed. The mixture was heated to 173° C. over 5 hours with stirring in a nitrogen atmosphere, to distill 27.3 kg of water. The autoclave was then closed. The p-DCB distilled by azeotropy during the dehydration was separated by the decanter, and at any time, was brought back to the autoclave. In the autoclave after completion of the dehydration, an anhydrous sodium sulfide composition was dispersed in p-DCB. Furthermore, the inner temperature was cooled to 160° C., 47.492 kg (479 moles) of NMP was added, and the inner temperature was heated to 185° C. When the pressure reached 0.00 MPa, a valve connected to the rectification tower was opened, and the inner temperature was heated to 200° C. over one hour. At that time, the outlet temperature of the rectification tower was controlled to be 110° C. or lower by cooling and a valve opening degree. The mixed vapor of distilled p-DCB and water was condensed by the condenser, and separated by the decanter, and the p-DCB was brought back to the autoclave. The amount of distilled water was 179 g. Subsequently, the inner temperature was heated from 200° C. to 230° C. over 3 hours, stirred for 1 hour, heated to 250° C., and stirred for 1 hour. A polymerization reaction was completed, to obtain a crude PPS mixture.

### Example 1—Step (1)

The crude PPS mixture obtained by polymerization in Synthesis Example 1 was heated to 250° C. and stirred, to dissolve PPS in NMP.

### Example 1—Step (2)

A bottom valve of the autoclave was opened, the solution was flushed into a 150-L receiver vessel with a stirrer blade that had been prepared under reduced pressure, and the receiver vessel was cooled to room temperature with a part of NMP being distilled off. Thus, crude PPS particles were obtained. The content of NMP in the resultant crude PPS particles was 135 parts by mass relative to 100 parts by mass of PPS, and the amount of sodium chloride was 108 parts by mass.

### Example 1—Step (3)

400 g of the resultant crude PPS particles and 422 g of methanol (“guaranteed reagent” available from FUJIFILM Wako Pure Chemical Corporation) were placed in a flask, and stirred and mixed at 40° C. for 30 minutes, and the slurry was filtered through Kiriyama funnel under reduced pressure, pressed from the above, and filtered by pouring 422 g of methanol dividedly several times from the above. The cake obtained by the filtration was transferred into a beaker, and crushed into a powder with a spatula, and 422 g of water at 20° C. was added to the powder, and stirred and mixed for 30 minutes. The resultant slurry was filtered through Kiriyama funnel under reduced pressure and pressed, 422 g of water at 20° C. was further poured dividedly several times from the above, and filtration was performed. The cake was transferred into a beaker, and 634 g of saturated carbonated water was poured, and stirred and mixed for 30 minutes. The slurry was filtered through Kiriyama funnel under reduced pressure, pressed from the above, and filtered by pouring 442 g of saturated carbonated water dividedly several times from the above, to give a water-containing PPS particles (adsorbent (1)). The evaluation results of the adsorbent (1) are shown in Table 1.

### Example 2

An adsorbent (2) was produced in the same manner as in Example 1 except that in the step (2) of Example 1, solid-liquid separation through flushing was changed to solid-liquid separation through crystallization under cooling by adjustment from 250° C. to 210° C. at 1° C./min. The evaluation results of the adsorbent (2) are shown in Table 1.

### Example 3

An adsorbent (3) was produced in the same manner as in Example 1 except that in the step (3) of Example 1, “the cake obtained by the filtration was transferred into a beaker, and crushed into a powder with a spatula, and 422 g of water at 20° C. was added to the powder, and stirred and mixed for 30 minutes” was changed to “the cake obtained by the filtration was transferred into an autoclave, and crushed into a powder with a spatula, and 422 g of water at 20° C. was added to the powder, heated to 200° C., and stirred and mixed for 30 minutes”. The evaluation results of the adsorbent (3) are shown in Table 1.

### Example 4

An adsorbent (4) was produced in the same manner as in Example 1 except that in the step (3) of Example 1, washing with methanol and washing with saturated carbonated water were not performed, and the number of water-washing was increased to five. The evaluation results of the adsorbent (4) are shown in Table 1.

### Example 5

A coupled autoclave in which two autoclaves are connected with a metal pipe was used, and a metal mesh having a mesh opening of 10 μm was provided in the pipe. In an autoclave (i), 200 g of PPS resin composition in which a PPS resin, calcium carbonate, and glass fibers were mixed at a ratio by weight of 100/85/90, 78 g of sodium chloride, and 432 g of NMP were placed, and stirred for 1 hour under heating to a liquid temperature of 250° C., to dissolve the PPS resin in NMP. An autoclave (ii) was heated to 250° C., and then depressurized, and the PPS dissolved in NMP was passed through the metal mesh and transferred from the autoclave (i) to the autoclave (ii) resulting in solid-liquid separation, to obtain crude PPS particles. After the solid-liquid separation, calcium carbonate and glass fibers were collected by the metal mesh. A subsequent step was performed in the same manner as the step (3) of Example 1, to produce an adsorbent (5). The evaluation results of the adsorbent (5) are shown in Table 1.

### Example 6

An adsorbent (6) was produced in the same manner as in Example 5 except that 77.8 g of sodium chloride was first added to the autoclave (ii) in Example 5. The evaluation results of the adsorbent (6) are shown in Table 1.

### Examples 7 to 10

The adsorption ratio of the substance to be separated that is different from that in Example 1 was evaluated using the adsorbent (1) produced in Example 1. The results are shown in Table 2.

### Comparative Example 1

An adsorbent (7) was produced in the same manner as in Example 1 except that in the step (3) of Example 1, the resultant water-containing PPS particles are dried at 150° C. over 4 hours. The evaluation results of the adsorbent (7) are shown in Table 1.

### Comparative Example 2

50 kg of the crude PPS mixture obtained in Synthesis Example 1 was heated to 250° C. and stirred, to dissolve PPS in NMP. Water was added dropwise using a high-pressure dropping pump such that a ratio by mole of water to NMP was 1/3, and the mixture was further stirred at 250° C. for 1 hour. Subsequently, the autoclave was annealed from 250° C. to 200° C. at 1° C./min. When the temperature reached 200° C., the autoclave was quenched to 80° C. A bottom valve of the autoclave was then opened, the mixture was transferred to a 150-L receiver vessel with a stirrer blade, and a crude PPS slurry was obtained. 400 g of the resultant crude PPS slurry was sieved through a metal mesh having a mesh opening of 500 μm, to remove a suspended material in a fine powder form of 500 μm or less together with a liquid phase component. The crude PPS particles left on the metal mesh and 800 g of water were placed in a flask, and stirred and mixed at 70° C. for 30 minutes, and the slurry was filtered under reduced pressure. This operation was repeated 7 times, and the slurry was dried under vacuum and used as an adsorbent (8) in evaluation. The evaluation results of the adsorbent (8) are shown in Table 1.

### Comparative Example 3

PPS resin (“DIC.PPS MA-505” available from DIC Corporation) and benzophenone (available from Kanto Chemical Co., Inc.) were mixed at a ratio by weight of 30/70, kneaded using a compact twin-screw extruder (“Compounder 15” manufactured by DSM XPlore) at a kneading temperature of 270° C. and a rotation number of 250 rpm for a residence time of 1 minute, and a melt in which the PPS resin and benzophenone were compatible was confirmed. Subsequently, the melt was extruded through a head installed in the compact twin-screw extruder. The extruded melt (extruded material) was passed through an air gap of 3.5 cm, led to a tank at 20° C. filled with a sufficient amount of ion exchanged water, and cooled and solidified. In the cooling and solidification process, the extruded material was cooled from 270° C. to 20° C. over 1.25 seconds, and the cooling rate was adjusted to 200° C./s. The solidified extruded material was immersed in acetone at 30° C., and subjected to an ultrasonic treatment for 30 minutes using an ultrasonic cleaner (US CLEANER USD-4R from AS ONE CORPORATION), to obtain porous particles. The porous particles collected from acetone were air-dried, dried for 3 hours using a vacuum dryer at 50° C., and used as an adsorbent (9) in evaluation. The evaluation results of the adsorbent (9) are shown in Table 1.

### Comparative Examples 4 to 7

The adsorption ratio of the substance to be separated that is different from that in Comparative Example 1 was evaluated using the adsorbent (7) produced in Comparative Example 1. The results are shown in Table 2.

TABLE 1

| | | | Ex. | Ex. | Ex. | Ex. | Ex. | Ex. | Comp. | Comp. | Comp. |
|---|---|---|---|---|---|---|---|---|---|---|---|
| | | | 1 | 2 | 3 | 4 | 5 | 6 | Ex. 1 | Ex. 2 | Ex. 3 |
| Adsorbent | | | 1 | 2 | 3 | 4 | 5 | 6 | 7 | 8 | 9 |
| Composition | PPS | wt % | 100 | 100 | 100 | 100 | 100 | 100 | 100 | 100 | 100 |
| | Water | wt % | 122 | 39 | 45 | 104 | 113 | 112 | <1 | <1 | <1 |
| Evaluation | Zeta | mV | −17 | −37 | −27 | −25 | −45 | −31 | −53 | −55 | −61 |
| | potential | | | | | | | | | | |
| | value | | | | | | | | | | |
| | Specific | m²/g | 105 | 47 | 45 | 97 | 98 | 98 | 9 | 43 | 65 |
| | surface | | | | | | | | | | |
| | area | | | | | | | | | | |
| | Au (III) | % | 100 | 61 | 65 | 91 | 43 | 88 | 5 | 13 | 0 |
| | Adsorption | | | | | | | | | | |
| | ratio | | | | | | | | | | |
| | Methanol | % | 97 | 57 | 47 | 65 | 35 | 77 | 5 | 7 | 3 |
| | adsorption | | | | | | | | | | |
| | ratio | | | | | | | | | | |

TABLE 2

| | | | Ex. | Ex. | Ex. | Ex. | Comp. | Comp. | Comp. | Comp. |
|---|---|---|---|---|---|---|---|---|---|---|
| | | | 7 | 8 | 9 | 10 | Ex. 4 | Ex. 5 | Ex. 6 | Ex. 7 |
| Adsorbent | | | 1 | 1 | 1 | 1 | 1 | 7 | 7 | 7 |
| Composition | PPS | wt % | 100 | 100 | 100 | 100 | 100 | 100 | 100 | 100 |
| | Water | wt % | 122 | 122 | 122 | 122 | 122 | <1 | <1 | <1 |
| Evaluation | Metal to be | | Pd | Pt | Fe | Ni | Pd | Pt | Fe | Ni |
| | adsorbed | | (III) | (IV) | (III) | (II) | (III) | (IV) | (III) | (II) |
| | Adsorption | % | 100 | 91 | 5 | 3 | 5 | 3 | 1 | 1 |
| | ratio | | | | | | | | | |

As confirmed from Tables 1 and 2, the adsorbents containing a PAS resin having a zeta potential of −50 mV or more of Examples are excellent in a property in which from a liquid containing a metal or an organic solvent as a substance to be separated, the substance to be separated is separated from the liquid.

1. A method for manufacturing an adsorbent, the method comprising:
a step (1) of heating a mixture (A) containing at least a polyarylene sulfide resin and an organic polar solvent at 200° C. or higher to dissolve the polyarylene sulfide resin in the organic polar solvent;
a step (2) of removing a part of a liquid-phase component by solid-liquid separation and then cooling the mixture (A) to a temperature equal to or lower than a glass transition temperature of the polyarylene sulfide resin to obtain a mixture (B); and
a step (3) of washing the mixture (B) by contact with water and removing a part of a liquid-phase component by solid-liquid separation to obtain a mixture (C) containing at least the polyarylene sulfide resin and water, wherein
an amount of the organic polar solvent contained in the mixture (B) is within a range of 50 parts by mass or more relative to 100 parts by mass of the polyarylene sulfide resin contained in the mixture (B), and
an amount of the water contained in the mixture (C) is within a range of 10 to 150 parts by mass relative to 100 parts by mass of the polyarylene sulfide resin contained in the mixture (C).

2. The method for manufacturing an adsorbent according to claim 1, wherein the solid-liquid separation in the step (2) is solid-liquid separation through a flash method.

3. The method for manufacturing an adsorbent according to claim 1, wherein a zeta potential measured at a pH of 7.8 to 8.2 through a streaming potential method of the polyarylene sulfide resin contained in the mixture (C) is-50 mV or more.

4. An adsorbent comprising a polyarylene sulfide resin having a zeta potential measured at a pH of 7.8 to 8.2 through a streaming potential method of −50 mV or more and water, wherein
an amount of water mixed is within a range of 10 to 150 parts by mass relative to 100 parts by mass of the polyarylene sulfide resin.

5. The adsorbent according to claim 4, wherein a specific surface area of the polyarylene sulfide resin is within a range of 10 to 300 m²/g.

6. A method for separating a metal from a liquid using the adsorbent according to claim 4.

7. A column filled with the adsorbent according to claim 4.

8. The method for manufacturing an adsorbent according to claim 2, wherein a zeta potential measured at a pH of 7.8 to 8.2 through a streaming potential method of the polyarylene sulfide resin contained in the mixture (C) is −50 mV or more.

9. A method for separating a metal from a liquid using the adsorbent according to claim 5.

10. A column filled with the adsorbent according to claim 5.
